(19) United States
(12) Patent Application Publication
(10) Pub. No.: US 2010/0046239 A1
(43) Pub. Date: Feb. 25, 2010

(54) LAMP HOUSING

(75) Inventors: CHUN-YU LIN, Tu-Cheng (TW); CHIA-CHUN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/274,195

(22) Filed: Nov. 19, 2008

(30) Foreign Application Priority Data
Aug. 21, 2008 (CN) 200810304129.6

(51) Int. Cl. F21V 29/00

(52) U.S. Cl. 362/373

(57) ABSTRACT

A lamp housing includes a top plate and sidewalls. The top plate includes a first edge, a second edge, a first group of top-plate dissipation slots and a plurality of second top-plate dissipation slots. The first edge is opposite to the second edge. Each top-plate dissipation slot has the same width, and is rectangular. Each one of the plurality of first top-plate dissipation slots is separated by two widths thereof, and each of the plurality of second top-plate dissipation slots is separated by two widths thereof. The plurality of first top-plate dissipation slots is parallel and 20 to 24 slot widths away from the first edge toward the center of the top plate, and the plurality of second dissipation slots is parallel and 14 to 18 slot widths away from the second edge. A plurality of sidewall dissipation slots is provided on the sidewalls.

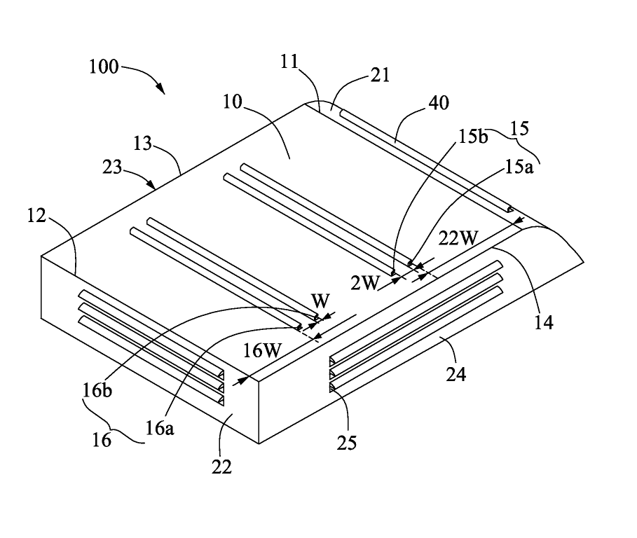

### BACKGROUND

1. Field of the Invention

The disclosure is related to illumination devices, especially to a lamp housing utilizing air convection to dissipate heat therefrom.

2. Description of Related Art

Light emitting diodes (LED) advantages such as low power consumption and long lifetime have promoted their application in lighting devices. However, temperature generated by LED lighting can seriously affect light efficiency and lifetime of the LED, making heat dissipation an important consideration when designing LED illumination systems.

Conventional dissipation of LED lamps utilize fins, fans, ventilation slots, or combinations thereof to conduct natural air convection. Slots are generally disposed in sidewalls of a LED housing, and often on the top as well. However, less-than-precise positioning of the ventilation slots results in poor dissipation. Therefore, what is needed is a lamp housing improving efficiency of heat dissipation.

### SUMMARY

A lamp housing comprising a top plate and sidewalls is disclosed, wherein the top plate comprises a first edge, a second edge, a plurality of first top-plate dissipation slots and a plurality of second top-plate dissipation slots. The first edge is opposite to the second edge. Each top-plate dissipation slot has the same width, and is elongated. Each one of the plurality of top-plate dissipation slots is separated by two widths thereof, and each of the plurality of second top-plate dissipation slots is separated by two widths thereof The plurality of first top-plate dissipation slots is parallel and arranged 20 to 24 widths thereof away from the first edge toward the center of the top plate, and the plurality of second dissipation ports is parallel and arranged 14 to 18 widths thereof away from the second edge. A plurality of sidewall dissipation slots are provided on the sidewalls.

The arrangement of ventilation slots of the lamp housing disclosed facilitates natural air convection inside the lamp housing, increases heat dissipation efficiency and further decreases temperature inside the lamp housing.

### BRIEF DESCRIPTION OF THE DRAWING

The FIGURE is an illustration of a lamp housing provided by the disclosure.

### DETAILED DESCRIPTION OF THE EMBODIMENTS

The FIGURE shows a lamp housing 100 as disclosed, including a top plate 10, a first sidewall 21, a second sidewall 22, a third sidewall 23, a fourth sidewall 24, and a blocking plate 40. The lamp housing 100 can be metal alloy or plastic.

The top plate 10 can be rectangular, having a first edge 11, a second edge 12 opposite to the first edge, a third edge 13, and a fourth edge 14 opposite to the third edge. The top plate 10 also comprises a plurality of elongated parallel first top-plate dissipation slots which includes dissipation slots 15a and 15b, and a second group of dissipation slots which includes dissipation slots 16a and 16b. Each of the dissipation slots 15a, 15b, 16a and 16b is elongated with a predetermined width (slot width hereinafter and represented as W in the FIGURE). Spacing between dissipation slots of the first group 15 can be as wide as two slot widths, or a distance 2W, and dissipation slots 16a and 16b are also separated by a distance 2W. The first group of dissipation slots 15 is parallel and arranged 20 to 24 slot widths away from the first edge 11 toward the center of the top plate 10. The second group of dissipation slots 16 is parallel and arranged 14 to 18 slot widths away from the second edge 12. In one embodiment of the disclosure, the dissipation slots 15a and the first edge 11 are separated by 22W, and the dissipation slots 16a and the second edge 12 are separated by a 16W distance. The top plate 10 can have an opening rate of 5.59%.

The first sidewall 21 and the second sidewall are opposite each other, and the third sidewall 23 and the fourth sidewall 24 are opposite each other. The first sidewall 21 is connected to the top plate 10 at the first edge 11, the second sidewall 22 is connected to the top plate 10 at the second edge 12, the third sidewall 23 is connected to the top plate at the third edge 13 and the fourth sidewall 24 is connected to the top plate 10 at the fourth edge 14. These sidewalls can be streamlined to promote airflow into the housing. Here, only the first sidewall 21 parallel to the dissipation slots 15a, 15b, 16a and 16b is streamlined to facilitate the sidewalls providing dissipation slots. Each sidewall can be formed integrally with the top plate 10, or connected to the top plate 10 by adhesive. Here, each sidewall and the top plate 10 are formed integrally.

A plurality of sidewall dissipation slots 25 is provided on the first sidewall 21, the second sidewall 22, the third sidewall 23 and the fourth sidewall 24. Here, three sidewall dissipation slots, separated evenly from each other and arranged parallel, are provided on the first sidewall 21, the second sidewall 22, the third sidewall 23 and the fourth sidewall 24. The porosity of the first sidewall 21 and the second sidewall 22 is 15.7%, and the porosity of the third sidewall 23 and the fourth sidewall 24 is 29.79%.

To prevent moisture entering the lamp housing and damaging the LED, the first group of dissipation slots 15, the second group of dissipation slots 16 and the plurality of sidewall dissipation slots 25 all provide a cover 40.

Using different sizes of openings on a top plate of the LED lamp results in different heat dissipation effects, even when other conditions, such as light source, lamp housing, number of openings on sidewalls, and number of openings on the top plate are unchanged. Experiment results show that when dissipation slot arrangement of the disclosure is applied to an LED lamp housing, maximum temperature inside the lamp housing decreases 10° C. to 20° C., compared to conventional arrangement of the lamp housing. The lamp housing disclosed effectively dissipates heat from inside the lamp housing by accelerating air convection.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A lamp housing comprising
a top plate comprising:
a first edge and an opposing second edge;
a plurality of elongated parallel first top-plate dissipation slots and a plurality of elongated parallel second top-plate dissipation slots, the first top-plate dissipation slots having a same width, and spaced a distance of two times the width of the first top-plate dissipation slots from each other; the second top-plate dissipation slots having the same width as the first top-plate dissipation slots, and spaced a distance of two times the width of the second top-plate dissipation slots from each other; one of the first top-plate dissipation slots nearest the first edge spaced a distance of 20 to 24 times the width from the first edge; one of the second dissipation slots nearest the second edge spaced a distance of in 14 to 18 times widths from the second edge; and
a plurality of sidewalls having a plurality of dissipation slots defined therein.

2. The lamp housing as claimed in claim 1, wherein the dissipation slots of the sidewalls are elongated.

3. The lamp housing as claimed in claim 1, wherein the top plate includes a plurality of covers stamped out adjacent to the respective first top-plate dissipation slots, the second top-plate dissipation slots, and the sidewall dissipation slots.

4. The lamp housing as claimed in claim 1, wherein the lamp housing is comprised of metal alloy or plastic.

5. The lamp housing as claimed in claim 1, wherein the plurality of first top-plate dissipation slots consist of two first top-plate dissipation slots and the second top-plate dissipation slots consist of two dissipation slots.

6. The lamp housing as claimed in claim 1, wherein at least one of the sidewalls is streamlined.

7. The lamp housing as claimed in claim 1, wherein each of the sidewalls has three sidewall dissipation slots.

8. The lamp housing as claimed in claim 1, wherein the top-plate is substantially rectangular.
